(19) United States
(12) Patent Application Publication
(10) Pub. No.: US 2024/0107634 A1
(43) Pub. Date: Mar. 28, 2024

(54) INDUCTION HEATING TYPE COOKTOP AND OPERATING METHOD THEREOF

(71) Applicant: LG ELECTRONICS INC., Seoul (KR)

(72) Inventors: Seungbok OK, Seoul (KR); Dooyong OH, Seoul (KR); Hojae SEONG, Seoul (KR); Byeongwook PARK, Seoul (KR)

(73) Assignee: LG ELECTRONICS INC., Seoul (KR)

(21) Appl. No.: 18/270,332

(22) PCT Filed: Jan. 29, 2021
(86) PCT No.: PCT/KR2021/001259

§ 371 Date: Jun. 29, 2023

(30) Foreign Application Priority Data
Dec. 31, 2020 (KR) 10-2020-0189868

(51) Int. Cl. H05B 6/06

(52) U.S. Cl. CPC H05B 6/062

(57) ABSTRACT

A cooktop includes a memory that stores material classification data; a measurement unit that acquires output values for each frequency in a search frequency range; and a material determination unit that compares the output values with the material classification data so as to obtain the material information of the cooking container.

### CROSS-REFERENCE TO RELATED APPLICATIONS

This application is the National Phase of PCT International Application No. PCT/KR2021/001259, filed on Jan. 29, 2021, which claims priority to and the benefit of Korean Patent Application No. 10-2020-0189868 filed in the Republic of Korea on Dec. 31, 2020, and all these applications are hereby incorporated by reference herein in their entireties.

### TECHNICAL FIELD

The present disclosure relates to an induction-type heating cooktop.

### BACKGROUND ART

Various types of cooking appliances are used to heat food at home or in the restaurant. According to the related art, a gas stove using gas as a fuel has been widely used. However, recently, devices for heating an object to be heated, for example, a cooking container such as a pot, have been spread using electricity instead of the gas.

A method for heating the object to be heated using electricity is largely divided into a resistance heating method and an induction heating method. The electrical resistance method is a method for heating an object to be heated by transferring heat generated when electric current flows through a metal resistance wire or a non-metal heating body such as silicon carbide to the object to be heated (e.g., a cooking container) through radiation or conduction. In the induction heating method, when high-frequency power having a predetermined intensity is applied to a coil, eddy current is generated in the object to be heated using magnetic fields generated around the coil so that the object to be heated is heated.

Recently, most of the induction heating methods are applied to cooktops. This induction heating type cooktop may provide various functions for user convenience. For example, a cooktop using the induction heating method may provide a function of detecting whether food in a cooking container currently being heated is boiling to inform the detected result to the user. For this, the induction heating type cooktop may first sense a temperature of the cooking container to predict a temperature of food based on the sensed temperature. In this instance, a relationship between a temperature of the cooking container and a temperature of food is changed according to a material, a thickness, and the like of the cooking container, and as a result, a malfunction, such as outputting of a notification even though the food is not boiled may occur. Therefore, the induction heating type cooktop requires a method of identifying characteristics of the cooking container.

### SUMMARY OF THE DISCLOSURE

An object of the present disclosure is to provide an induction heating type cooktop capable of distinguishing cooking containers and an operating method thereof.

An object of the present disclosure is to provide an induction heating type cooktop capable of identifying characteristics of a cooking container and an operating method thereof.

In a cooktop and an operating method thereof according to an embodiment of the present disclosure, an output value for each material characteristic of the cooking container in a predetermined frequency range is stored in advance to compare outputs measured before performing a heating mode with the previously stored output values, thereby identifying material characteristics of the cooking container.

In addition, in a cooktop and an operating method thereof according to an embodiment of the present disclosure, material classification data that is previously stored may be stored in a regression form so as to obtain material information of the cooking container.

In addition, in a cooktop and an operating method thereof according to an embodiment of the present disclosure, material information of a cooking container may be acquired using an error sum between output values measured through the measurement unit and output values according to material classification data.

### Advantageous Effects

According to the present disclosure, since the material classification data for the predetermined frequency range is stored, there may be an advantage in that the ability to distinguish the material characteristics of the cooking container is improved compared to the instance of using the measured values at the fixed number of frequencies, and thus, the accuracy of the material classification is improved.

In addition, since the material classification data for the predetermined frequency range is not stored as the individual output values, but stored in the regression form, there may be the advantage in that the memory space occupied by the material classification data is saved.

In addition, since the material of the cooking container is recognized by calculating the error sum for the predetermined frequency range without comparing the errors for each frequency, there may be the advantage in which the accuracy of the material recognition is improved by reducing the data dispersion.

Further scope of applicability of the invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a perspective view illustrating a cooktop and a cooking container according to an embodiment of the present disclosure.

FIG. 2 is a cross-sectional view illustrating the cooktop and the cooking container according to an embodiment of the present disclosure.

FIG. 3 is a circuit diagram of the cooktop according to an embodiment of the present disclosure.

FIG. 4 is a view illustrating output characteristics of the cooktop according to an embodiment of the present disclosure.

FIG. 5 is a control block diagram of the cooktop according to an embodiment of the present disclosure.

FIGS. 6 and 7 are views for explaining material classification data stored in the cooktop according to an embodiment of the present disclosure.

FIG. 8 is a flowchart illustrating an operating method of the cooktop according to an embodiment of the present disclosure.

FIG. 9 is a flowchart illustrating a method for operating in a material determination mode according to an embodiment of the present disclosure.

FIG. 10 is a view illustrating a first condition in which the cooktop terminates frequency scanning according to an embodiment of the present disclosure.

FIG. 11 is a view illustrating a second condition in which the cooktop terminates frequency scanning according to an embodiment of the present disclosure.

FIG. 12 is a view illustrating a third condition in which the cooktop terminates frequency scanning according to an embodiment of the present disclosure.

FIG. 13 is a flowchart illustrating a method for comparing output data with the material classification data in the cooktop according to an embodiment of the present disclosure.

FIG. 14 is a view for explaining a method for comparing the output data with the material classification data in the cooktop according to an embodiment of the present disclosure.

FIG. 15 is a view illustrating an example of a method for detecting a material characteristic regression equation in which the sum of errors is calculated to be the smallest in the cooktop according to an embodiment of the present disclosure.

### DETAILED DESCRIPTION OF THE EMBODIMENTS

Hereinafter, embodiments relating to the present disclosure will be described in detail with reference to the accompanying drawings. Furthermore, terms, such as a “module” ad a “unit”, are used for convenience of description, and they do not have different meanings or functions in themselves.

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs.

Hereinafter, an induction heating type cooktop and an operation method thereof according to an embodiment of the present disclosure will be described. For convenience of description, the “induction heating type cooktop” is referred to as a “cooktop”.

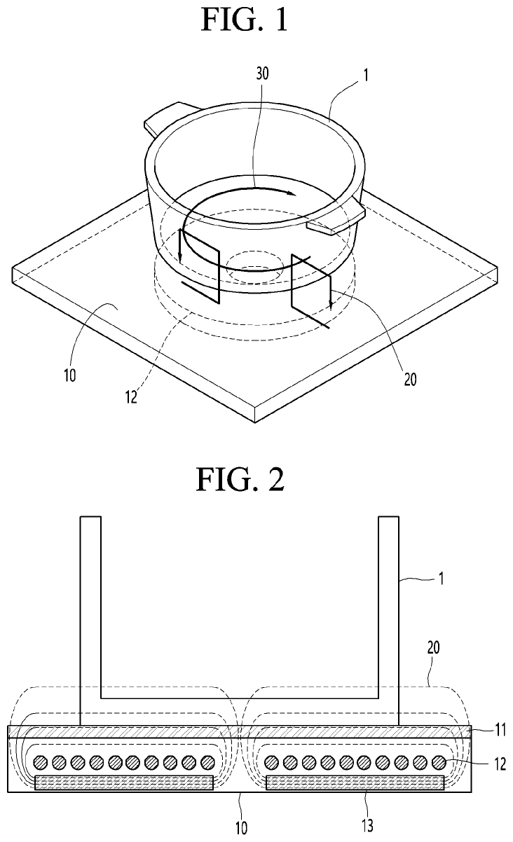

FIG. 1 is a perspective view illustrating a cooktop and a cooking container according to an embodiment of the present disclosure, and FIG. 2 is a cross-sectional view illustrating the cooktop and the cooking container according to an embodiment of the present disclosure.

A cooking container 1 can be disposed above a cooktop 10 (e.g., induction cooktop), and the cooktop 10 can heat a cooking container 1 disposed thereon.

First, a method for heating the cooking container 1 using the cooktop 10 will be described.

As illustrated in FIG. 1, the cooktop 10 (e.g., induction cooktop) can generate a magnetic field 20 so that at least a portion of the magnetic field 20 passes through the cooking container 1. Here, if an electrical resistance component is contained in a material of the cooking container 1, the magnetic field 20 can induce an eddy current 30 in the cooking container 1. Since the eddy current 30 generates heat in the cooking container 1 itself, and the heat is conducted or radiated up to the inside of the cooking container 1, contents of the cooking container 1 can be cooked.

When the material of the cooking container 1 does not contain the electrical resistance component, the eddy current 30 does not occur. Thus, in this instance, the cooktop 10 may not heat the cooking container 1.

As a result, the cooking container 1 capable of being heated by the cooktop 10 can be a stainless steel container or a metal container such as an enamel or cast iron container. The cooking container can contain a ferrous metal, such as carbon steel, cast iron, enameled, stainless steel, or any known material having high magnetic permeability, and can have a thickness in a predetermined range to allow for proper current flow from the cooktop 10 to the cooking container 1. The cooktop 10 can include a heat-proof glass ceramic top surface above a coil of wire, such as copper wire, and the wire can have a low radio frequency alternating electric current passing through it to result in an oscillating electromagnetic field induces an electrical current in the cooking container 1. A large eddy current flowing through a resistance of the metal in the base of the cooking container 1 can result in resistive heating.

Next, a method for generating the magnetic field 20 by the cooktop 10 will be described.

As illustrated in FIG. 2, the cooktop 10 can include at least one of an upper plate glass 11, a working coil 12, or a ferrite 13.

The upper plate glass 11 can support the cooking container 1. That is, the cooking container 1 can be placed on a top surface of the upper plate glass 11.

In addition, the upper plate glass 11 can be made of ceramic tempered glass obtained by synthesizing various mineral materials. Thus, the upper plate glass 11 can protect the cooktop 10 from an external impact.

In addition, the upper plate glass 11 can prevent foreign substances such as dust from being introduced into the cooktop 10.

The working coil 12 can be disposed below the upper plate glass 11. Current can or may not be supplied to the working coil 12 to generate the magnetic field 20. Specifically, the current can or may not flow through the working coil 12 according to on/off of an internal switching element of the cooktop 10.

When the current flows through the working coil 12, the magnetic field 20 can be generated, and the magnetic field 20 can generate the eddy current 30 by meeting the electrical resistance component contained in the cooking container 1. The eddy current can heat the cooking container 1, and thus, the contents of the cooking container 1 can be cooked.

In addition, heating power of the cooktop 10 can be adjusted according to an amount of current flowing through the working coil 12. As a specific example, as the current flowing through the working coil 12 increases, the magnetic field 20 can be generated more, and thus, since the magnetic field passing through the cooking container 1 increases, the heating power of the cooktop 10 can increase.

The ferrite 13 is a component for protecting an internal circuit of the cooktop 10. Specifically, the ferrite 13 serves as a shield to block an influence of the magnetic field 20 (e.g., block electromagnetic interference (EMI)) generated from the working coil 12 or an electromagnetic field generated from the outside on the internal circuit of the cooktop 10.

For this, the ferrite 13 can be made of a material having very high permeability. The ferrite 13 serves to induce the magnetic field introduced into the cooktop 10 to flow through the ferrite 13 without being radiated. The movement of the magnetic field 20 generated in the working coil 12 by the ferrite 13 can be as illustrated in FIG. 2.

The cooktop 10 can further include components other than the upper glass 11, the working coil 12, and the ferrite 13 described above. For example, the cooktop 10 can further include an insulator disposed between the upper plate glass 11 and the working coil 12. That is, the cooktop according to the present disclosure is not limited to the cooktop 10 illustrated in FIG. 2.

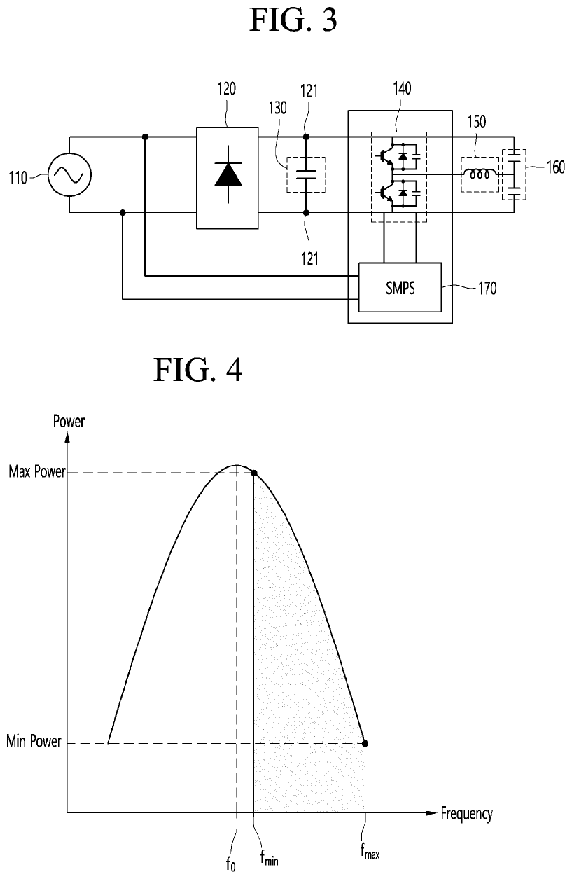

FIG. 3 is a circuit diagram of the cooktop according to an embodiment of the present disclosure.

Since the circuit diagram of the cooktop 10 illustrated in FIG. 3 is merely illustrative for convenience of description, the embodiment of the present disclosure is not limited thereto.

Referring to FIG. 3, the induction heating type cooktop can include at least some or all of a power supply 110, a rectifier 120, a DC link capacitor 130, an inverter 140, a working coil 150, a resonance capacitor 160, and a switched-mode power supply (SMPS) 170. The rectifier 120 can be connected in parallel to the DC link capacitor 130, and can be connected in parallel to power supply 110.

The power supply 110 can receive external power. Power received from the outside to the power supply 110 can be alternating current (AC) power.

The power supply 110 can supply an AC voltage to the rectifier 120. The rectifier 120 is an electrical device for converting alternating current into direct current. The rectifier 120 converts the AC voltage supplied through the power supply 110 into a direct current (DC) voltage. The rectifier 120 can supply the converted voltage to both DC ends 121 (e.g., nodes, ends 121 of the DC output of the rectifier 120).

An output terminal of the rectifier 120 can be connected to both the DC ends 121. Each of both the ends 121 of the DC output through the rectifier 120 can be referred to as a DC link. A voltage measured at each of both the DC ends 121 is referred to as a DC link voltage.

A DC link capacitor 130 serves as a buffer between the power supply 110 and the inverter 140. That is, the DC link capacitor 130 can stabilize voltage distributed between the power supply 110 and the inverter 140, as known in the art. Specifically, the DC link capacitor 130 is used to maintain the DC link voltage converted through the rectifier 120 to supply the DC link voltage to the inverter 140.

The inverter 140 serves to switch the voltage applied to the working coil 150 so that high-frequency current flows through the working coil 150. The inverter 140 drives the switching element constituted by insulated gate bipolar transistors (IGBTs) to allow high-frequency current to flow through the working coil 150, and thus, a high-frequency magnetic field is generated in the working coil 150.

In the working coil 150, current can or may not flow depending on whether the switching element is driven. When current flows through the working coil 150, magnetic fields are generated. The working coil 150 can heat an cooking appliance by generating the magnetic fields as the current flows.

One side (e.g., a first side) of the working coil 150 is connected to a connection point of the switching element of the inverter 140, and the other side (e.g., a second side) is connected to the resonance capacitor 160.

The switching element is driven by a driver, as known in the art, and a high-frequency voltage is applied to the working coil 150 while the switching element operates alternately by controlling a switching time output from the driver. In addition, since a turn on/off time of the switching element applied from the driver is controlled in a manner that is gradually compensated, the voltage supplied to the working coil 150 is converted from a low voltage into a high voltage.

The resonance capacitor 160 can be a component to serve as a buffer. The resonance capacitor 160 controls a saturation voltage increasing rate during the turn-off of the switching element to affect an energy loss during the turn-off time.

The switching mode power supply (SMPS) 170 (switching mode power supply) refers to a power supply that efficiently converts power according to a switching operation. The SMPS 170 converts a DC input voltage into a voltage that is in the form of a square wave and then obtains a controlled DC output voltage through a filter. That is, the SMPS 170 can convert voltage and current characteristics and continually switches between low-dissipation, full-on and full-off states, where voltage regulation is achieved by varying the ratio of on-to-off time (also known as duty cycles). The SMPS 170 can minimize an unnecessary loss by controlling a flow of the power using a switching processor.

In the instance of the cooktop 10 expressed by the circuit diagram illustrated in FIG. 3, a resonance frequency is determined by an inductance value of the working coil 150 and a capacitance value of the resonance capacitor 160. Then, a resonance curve can be formed around the determined resonance frequency, and the resonance curve can represent output power of the cooktop 10 according to a frequency band.

Next, FIG. 4 is a view illustrating output characteristics of the cooktop according to an embodiment of the present disclosure.

First, a Q factor (quality factor) can be a value representing sharpness of resonance in the resonance circuit. Therefore, in the instance of the cooktop 10, the Q factor is determined by the inductance value of the working coil 150 included in the cooktop 10 and the capacitance value of the resonant capacitor 160. The resonance curve can be different depending on the Q factor. Thus, the cooktop 10 has different output characteristics according to the inductance value of the working coil 150 and the capacitance value of the resonant capacitor 160.

FIG. 4 illustrates an example of the resonance curve according to the Q factor. In general, the larger the Q factor, the sharper the shape of the curve, and the smaller the Q factor, the broader the shape of the curve.

A horizontal axis of the resonance curve can represent a frequency, and a vertical axis can represent output power in watt (W). A frequency at which maximum power is output in the resonance curve is referred to as a resonance frequency f₀.

In general, the cooktop 10 uses a frequency in a right region based on the resonance frequency f₀ of the resonance curve. In addition, the cooktop 1 can have a minimum operating frequency fₘᵢₙ and a maximum operating frequency fₘₐₓ, which are set in advance.

For example, the cooktop 10 can operate at a frequency corresponding to a range from the maximum operating frequency fₘₐₓ to the minimum operating frequency fₘᵢₙ. That is, the operating frequency range of the cooktop 10 can be from the maximum operating frequency fₘₐₓ to the minimum operating frequency fₘᵢₙ.

For example, the maximum operating frequency fₘₐₓ of an insulated-gate bipolar transistor (IGBT) of the inverter 140, which is an IGBT maximum switching frequency. The IGBT maximum switching frequency can mean a maximum driving frequency in consideration of a resistance voltage and capacity of the IGBT switching element. For example, the maximum operating frequency fₘₐₓ can be 75 kHz.

The minimum operating frequency fₘᵢₙ can be about 20 kHz. In this instance, since the cooktop 10 does not operate at an audible frequency (about 16 Hz to 20 kHz), noise of the cooktop 10 can be reduced.

Since setting values of the above-described maximum operating frequency fₘₐₓ and minimum operating frequency fₘᵢₙ are only examples, the embodiment of the present disclosure is not limited thereto.

When receiving a heating command, the cooktop 10 can determine an operating frequency according to a heating power level set by the heating command. Specifically, the cooktop 10 can adjust the output power by decreasing in operating frequency as the set heating power level is higher and increasing in operating frequency as the set heating power level is lower. That is, when receiving the heating command, the cooktop 10 can perform a heating mode in which the cooktop operates in one of the operating frequency ranges according to the set heating power.

When receiving the heating command, the cooktop 10 according to an embodiment of the present disclosure can operate in a material determination mode before operating in the heating mode according to the heating command.

The material determination mode can be an operation mode for acquiring material information of the cooking container 1 placed on the cooktop 10.

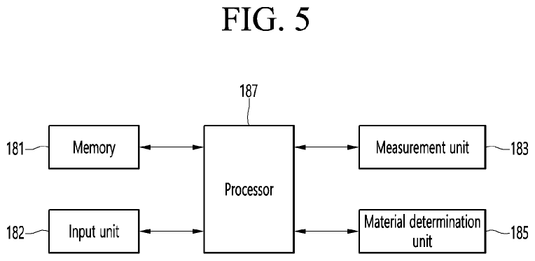

FIG. 5 is a control block diagram of the cooktop according to an embodiment of the present disclosure.

The cooktop 10 according to an embodiment of the present disclosure can include at least some or all of a non-transitory memory 181, an input unit 182, a measurement unit 183, a material determination unit 185, and a processor 187. The processor 187 can comprise the input unit 182, the measurement unit 183 and the material determination unit 185.

The memory 181 can store material classification data.

The material classification data can be data used to classify a material of the cooking container 1 placed on the cooktop 1. The material classification data stored in each cooktop 10 can vary depending on the performance and types of the cooktops 1. The material classification data can include previously acquired output values in a predetermined frequency range for each material characteristic of the cooking container 1.

The material classification data can include regression equations in which output values (e.g., resonant current or phase, etc.) for each frequency are derived for the predetermined frequency range, and each regression equation can be classified for each material characteristic of the cooking container 1. That is, the material classification data can be expressed as a regression equation for each container material calculated on the basis of previously acquired output values.

In the present disclosure, it is assumed that the output value is resonant current, that is, a current value flowing through the working coil 150. However, this is merely an example, and which one to measure as the output value for each frequency can be changed depending on a design.

Specifically, the material classification data can include a first regression equation for a first material characteristic, a second regression equation for a second material characteristic, a third regression equation for a third material characteristic, . . . , an N-th regression equation for an N-th material characteristic. Here, each of the first to N-th material characteristics can be classified according to the types of materials of the cooking container 1 (e.g., stainless steel, enamel, cast iron, metal, etc.), or even if the types of materials of the cooking container 1 are the same, the first to N-th material characteristics can be classified according to a manufacturer of the cooking container 1, a thickness of the cooking container 1, and the like.

The first to N-th regression equations can be derived from experimental results directly measured for the cooking containers 1 having various material properties.

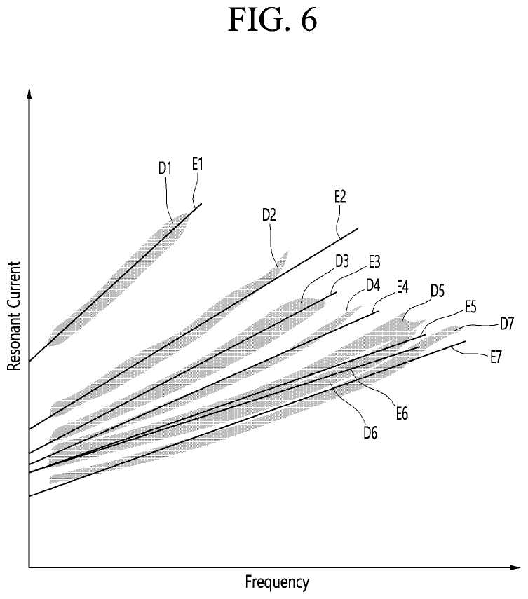

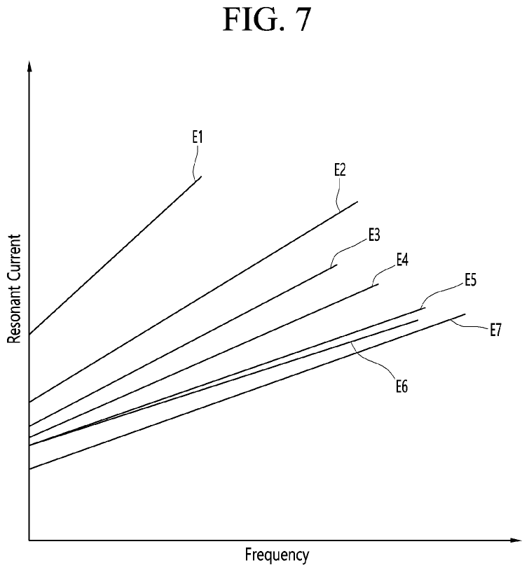

FIGS. 6 to 7 are views for explaining the material classification data stored in the cooktop according to an embodiment of the present disclosure.

First dots D1 can be output values (e.g., resonant current) for each frequency when the cooking container 1 having the first material characteristic is placed on the cooktop 1, and the first regression equation E1 can be derived by the first points D1.

Second dots D2 can be output values (e.g., resonant current) for each frequency when the cooking container 1 having the second material characteristic is placed on the cooktop 1, and the second regression equation E1 can be derived by the second points D2.

Third dots D3 can be output values (e.g., resonant current) for each frequency when the cooking container 1 having the third material characteristic is placed on the cooktop 1, and the third regression equation E1 can be derived by the third points D3.

Fourth dots D4 can be output values (e.g., resonant current) for each frequency when the cooking container 1 having the fourth material characteristic is placed on the cooktop 1, and the fourth regression equation E1 can be derived by the fourth points D4.

Fifth dots D5 can be output values (e.g., resonant current) for each frequency when the cooking container 1 having the fifth material characteristic is placed on the cooktop 1, and the fifth regression equation E1 can be derived by the fifth points D5.

Sixth dots D6 can be output values (e.g., resonant current) for each frequency when the cooking container 1 having the sixth material characteristic is placed on the cooktop 1, and the sixth regression equation E1 can be derived by the sixth points D6.

Seventh dots D7 can be output values (e.g., resonant current) for each frequency when the cooking container 1 having the seventh material characteristic is placed on the cooktop 1, and the seventh regression equation E1 can be derived by the seventh points D7.

The curves illustrated in FIG. 7 can be curves representing the first to seventh regression equations E1 to E7.

In FIGS. 6 and 7, only the first to seventh regression equations for the cooking container 1 having the first to seventh material characteristics are shown, but these are merely an example, and the number of regression equations can be more or less.

As described above, when the material classification data is acquired for the predetermined frequency range, the discrimination performance can be improved compared to the instance in which the material classification data is acquired for the fixed predetermined number of frequencies, and thus, there can be an advantage in that accuracy of the material classification is improved.

In addition, since the material classification data is not stored as the output values for the predetermined frequency range, but stored in the regression form, there can be an advantage in that a memory space occupied by the material classification data is saved.

According to an embodiment, the material identification data can be stored as the output values for each frequency belonging to the predetermined frequency range.

The input unit 182 can receive a user input. For example, the input unit 182 can receive a heating power selection input, a heating start/end input, and the like.

The measurement unit 183 can perform frequency scanning in the material determination mode. The frequency scanning can refer to an operation of acquiring output data by measuring the output values at each frequency while sequentially changing frequencies in a search frequency range. The output data can be constituted by the output values measured at each frequency. The measurement unit 183 can be any known device that can measure the resonant current of the working coil 12, such as a current sensor, a device to measure the voltage through the working coil 12, such as a voltmeter, and the like.

The material determination unit 185 can acquire material information of the cooking container 1 placed on the cooktop 1. As a specific example, the material determination unit 185 can acquire material information of the cooking container 1 using the output data acquired by the measurement unit 183.

The processor 187 can control at least some or all of the memory 181, the input unit 182, the measurement unit 183, and the material determination unit 185. In addition, the processor 187 can control each of the internal components of the cooktop 1.

Each of the configurations of the cooktop 10 illustrated in FIG. 5 is only classified for convenience of description and is not limited thereto. That is, the components of the cooktop 10 illustrated in FIG. 5 can be integrally formed without being separated from each other or can further include other components.

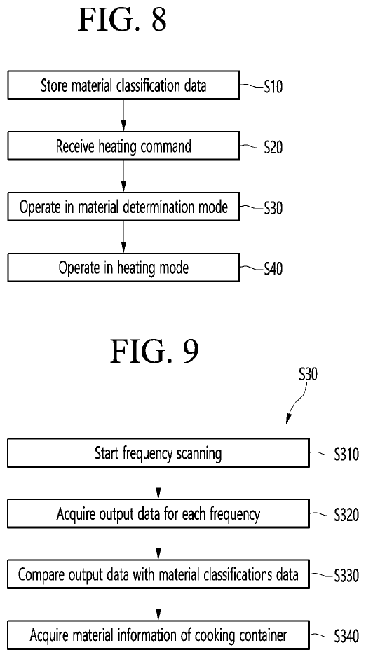

FIG. 8 is a flowchart illustrating an operating method of the cooktop according to an embodiment of the present disclosure.

The cooktop 1 can store material classification data (S10).

As the material classification data has been described in detail above, duplicated descriptions will be omitted.

The material classification data can be stored as default when the cooktop 1 is manufactured.

In addition, according to an embodiment, the material classification data stored in the cooktop 1 can be supplemented in a process of use. For example, as a use time of the cooktop 1 is accumulated, an error rate of the material classification data can increase, as abrasion and performance degradation of parts occur. In order to improve such an error, a supplementary mode of correcting at least one regression equation can be implemented.

The cooktop 1 can receive a heating command (S20).

The cooktop 1 can receive the heating command through the input unit 182. The input unit 182 can receive a command to select a heating power level when receiving the heating command. For example, the input unit 182 can receive the heating command with a heating power level 3, but this is merely an example.

When receiving the heating command, the cooktop 1 can operate in a material determination mode (S30).

When receiving the heating command, the processor 187 can perform the material determination mode before executing the heating mode. That is, the cooktop 1 can operate in the heating mode after operating in the material determination mode.

FIG. 9 is a flowchart illustrating a method for operating in the material determination mode according to an embodiment of the present disclosure.

FIG. 9 illustrates a flowchart embodying the operation S30 of FIG. 8.

The processor 187 can control the measurement unit 183 (e.g., measurement device 183) to start the frequency scanning (S310).

The measurement unit 183 can perform the frequency scanning for the search frequency range regardless of the heating power level according to the heating command.

The search frequency range can refer to a range of frequencies to be sequentially controlled before the heating mode in order to acquire the material information of the cooking container 1.

The measurement unit 183 can select the search frequency range from the first frequency to the second frequency.

Here, the first frequency can be a maximum operating frequency. Alternatively, the first frequency can be any one of values within a predetermined ratio (e.g., 5%) of the maximum operating frequency. That is, the first frequency can be equal to or less than the maximum operating frequency.

This first frequency can be a fixed value. The first frequency can be determined by the performance of the cooktop 1.

The second frequency can be a value determined by specific operating conditions. The second frequency can include an operating frequency when the cooktop 1 has a maximum power level, an operating frequency when maximum current flows through the working coil 150, and a minimum operating frequency. That is, the measurement unit 183 can terminate the frequency scanning when the frequency reaches the operating frequency when reaching the maximum power level, the operating frequency when the maximum current flows through the working coil 150, or the minimum operating frequency.

Next, the processor 187 can acquire output data for each frequency (S320) by measuring the output values at each frequency while sequentially changing frequencies in a search frequency range. The output data can be constituted by the output values measured at each frequency.

Next, the material determination unit 185 can compare the output data with stored material classifications data (S330). Then the processor 187 can acquire material information of the container (S340).

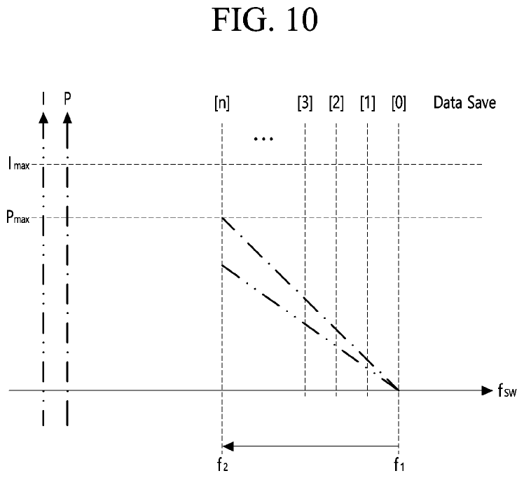

Next, with reference to FIGS. 10 to 12, conditions for the cooktop 10 to terminate the frequency scanning will be described.

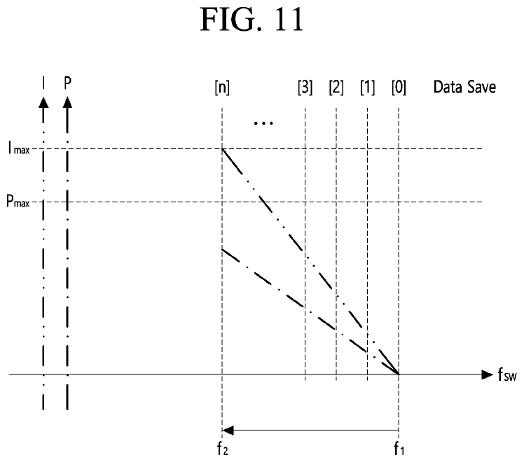

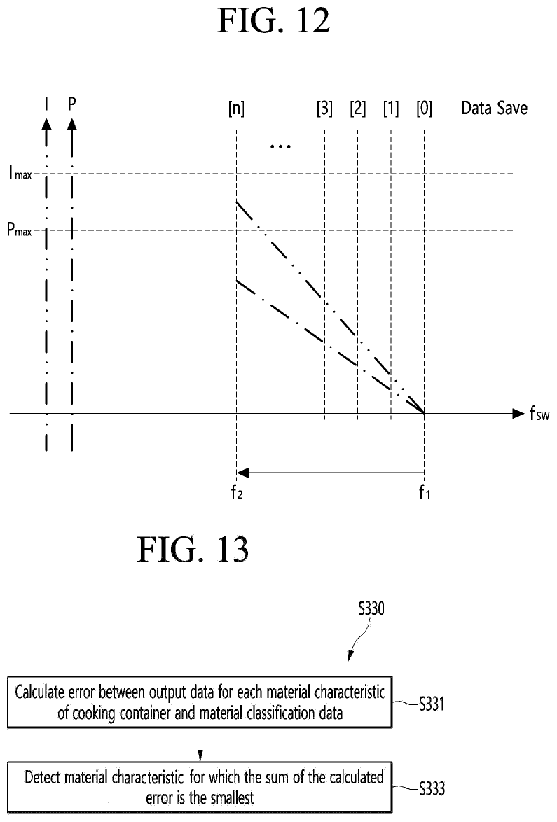

FIG. 10 is a view illustrating a first condition in which the cooktop terminates the frequency scanning according to an embodiment of the present disclosure, FIG. 11 is a view illustrating a second condition in which the cooktop terminates the frequency scanning according to an embodiment of the present disclosure, and FIG. 12 is a view illustrating a third condition in which the cooktop terminates the frequency scanning according to an embodiment of the present disclosure.

When the frequency scanning is started, the cooktop 1 can measure and store, for example, in memory 181, output values at each frequency, while sequentially reducing the frequency starting from the first frequency (f1). Also, the cooktop 1 can sense output power of the cooktop and current flowing through the working coil 150 while performing the frequency scanning.

As illustrated in FIG. 10, the cooktop 1 can terminate the frequency scanning when the output power P reaches a maximum output power Pmax, which may be at the second frequency f2. That is, the frequency scanning can start at an initial frequency f1, then reaching various frequency levels [1], [2], [3], and end at frequency f2, which can be the frequency when the maximum output power Pmax is reached. Alternatively, the cooktop 1 can terminate the frequency scanning when the current I flowing through the working coil 150 reaches maximum allowable current Imax, as illustrated in FIG. 11. Alternatively, in the cooktop 1, as shown in FIG. 12, the output power P does not reach the maximum output power Pmax, and the current I flowing through the working coil 150 does not reach the maximum allowable current Imax, but the frequency scanning can be terminated when the operating frequency (switching frequency) reaches the minimum operating frequency fₘᵢₙ.

In other words, the measurement unit 183 can terminate the frequency scanning when the maximum output of a burner is reached (e.g., maximum output power Pmax), the maximum allowable current of the working coil (maximum allowable current Imax), or the minimum operating frequency fₘᵢₙ.

This termination of the frequency scanning is to allow the cooktop 1 to operate in a stable region. Specifically, the wider the search frequency range is set, the better the discrimination performance of the material discrimination, but an increased risk of burnout of the inverter 140. Therefore, the frequency of the inverter 140 is limited by limiting the second frequency to a frequency under a specific operating condition (e.g., when the maximum thermal power is applied, when the maximum current flows through the working coil 150, or when the minimum operating frequency operates) to minimize the burnout problems.

Again, FIG. 9 will be described.

The measurement unit 183 can acquire output data for each frequency (S320).

The measurement unit 183 can acquire output data by measuring output values for each frequency through the frequency scanning. The measurement unit 183 can acquire output data while sequentially reducing the operating frequency from the first frequency to the second frequency. That is, the measurement unit 183 can acquire the measured output values as the output data while adjusting the operating frequency to each frequency corresponding to the search frequency range.

The material determination unit 185 can compare the output data with the material classification data (S330).

FIG. 13 is a flowchart illustrating a method for comparing the output data with the material classification data in the cooktop according to an embodiment of the present disclosure.

That is, FIG. 13 illustrates a flowchart embodying the operation S330 of FIG. 9.

The material determination unit 185 can calculate an error between the output data and the material classification data for each material characteristic of the cooking container 1 (S331).

The material determination unit 185 can calculate errors by calculating a difference operation between the output values measured by the measurement unit 183 and the output values according to the material classification data.

Specifically, the material determination unit 185 can calculate an error between an output value for each frequency according to the regression equation and an output value for each frequency of the output data for each regression equation for each material characteristic.

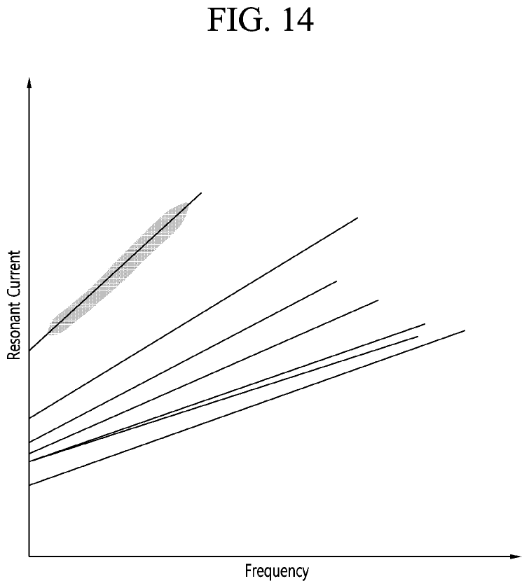

FIG. 14 is a view for explaining a method for comparing the output data with the material classification data in the cooktop according to an embodiment of the present disclosure.

As illustrated in FIG. 14, the output data can be input to the material classification data.

The material determination unit 185 can detect material characteristics for which the sum of the calculated errors is the smallest (S333).

The material determination unit 185 can calculate the sum of the errors by calculating the sum of absolute values of the errors.

Specifically, the material determination unit 185 can calculate the sum of errors calculated for each material characteristic.

That is, the material determination unit 185 can calculate the sum of errors between the output value for each frequency according to the first material characteristic regression equation and the output value for each frequency of the output data, calculate the sum of errors between the output value for each frequency according to the second material characteristic regression equation and the output value for each frequency of the output data, . . . , and calculate the sum of errors between the output value for each frequency according to the third material characteristic regression equation and the output value for each frequency of the output data.

The material determination unit 185 can detect a material characteristic regression equation in which the error sum is the smallest among the calculated error sum.

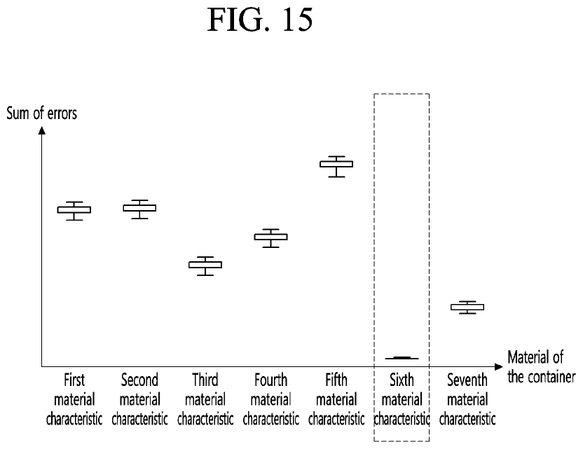

FIG. 15 is a view illustrating an example of a method for detecting the material characteristic regression equation in which the sum of errors is calculated to be the smallest in the cooktop according to an embodiment of the present disclosure.

As illustrated in FIG. 15, the material determination unit 185 can detect the material characteristic for which the error sum is the smallest among the calculated error sums. FIG. 15 illustrates seven (first to seventh) different material characteristics, each material characteristic having a different error sum. The error sum can be an identifying feature of the material characteristics, in order to determine which material is present in the cooking container 10.

FIG. 9 will be described again.

The material determination unit 185 can acquire material information of the cooking container 1 based on a comparison result between the output data and the material classification data (S340).

The material determination unit 185 can calculate an error between the output data and the material classification data for each frequency corresponding to the search frequency range, and recognize the material characteristic for which the sum of the calculated errors is the smallest as the material of the cooking container.

That is, the material determination unit 185 can recognize the material characteristic corresponding to the material characteristic regression equation in which the error sum is the smallest as the material information of the cooking container 1.

Again, FIG. 8 will be described.

When the material information of the cooking container 1 is acquired, the material determination unit 185 can terminate the material determination mode to operate in the heating mode (S30).

The processor 187 can operate in the heating mode by reflecting the material information of the cooking container 1 determined in the material determination mode. That is, the processor 187 can differently control the operation method in the heating mode when the material information of the cooking container acquired in the material determination mode is different with respect to the same heating command. For example, the processor 187 can differently control the operating frequency in the heating mode even if the heating power level is the same when the cooking container 1 determined in the material determination mode is different.

As described above, the cooktop 10 according to the present disclosure can recognize the material of the cooking container 1 by calculating the error sum for the predetermined frequency range without recognizing the material of the cooking container 1 through the comparison of each frequency. Therefore, there can be an advantage of improving accuracy of the material recognition by reducing data dispersion.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1-17. (canceled)

18. A cooktop configured to heat a cooking container, the cooktop comprising:
a non-transitory memory configured to store material classification data;
a measurement unit configured to measure output values for each frequency among a search frequency range; and
a processor configured to compare the measured output values with predetermined output values corresponding to the material classification data to acquire material information of the cooking container.

19. The cooktop according to claim 18, wherein the processor is further configured to:
calculate errors between the measured output values and the predetermined output values; and
determine the material of the cooking container based on the calculated errors.

20. The cooktop according to claim 19, wherein the processor is further configured to calculate a sum of the errors through a sum operation of absolute values of the errors.

21. The cooktop according to claim 20, wherein the processor is further configured to determine the material of the cooking container as having a smallest sum of the calculated errors.

22. The cooktop according to claim 18, wherein the processor is further configured to perform a material determination mode for acquiring the material information of the cooking container before a heating mode is performed.

23. The cooktop according to claim 22, wherein the processor is further configured to differently control an operation method in the heating mode based on the material information of the cooking container acquired in the material determination mode, with respect to a same heating command.

24. The cooktop according to claim 18, wherein the measurement unit is configured to set the search frequency range from a first frequency to a second frequency,
wherein the first frequency is less than or equal to a maximum operating frequency of the cooktop, and
wherein the second frequency comprises an operating frequency when a maximum power is applied and an operating frequency when a maximum current flows through a working coil of the cooktop.

25. The cooktop according to claim 24, wherein the measurement unit is configured to measure the output values for each frequency while sequentially reducing the operating frequency from the first frequency to the second frequency.

26. The cooktop according to claim 18, wherein the measurement unit is configured to measure the output values for each frequency while adjusting current flowing through a working coil of the cooktop.

27. The cooktop according to claim 18, wherein the material classification data comprises a regression equation for each material of the container among a plurality of materials, and
wherein the regression equation is calculated based on output values previously acquired in a predetermined frequency range for each material characteristic of the cooking container.

28. The cooktop according to claim 18, wherein the stored material classification data includes resonant current and frequency for a plurality of materials.

29. An operation method of a cooktop, comprising:
storing material classification data in a non-transitory memory;
measuring output values for each frequency in a search frequency range; and
acquiring material information of the cooking container by comparing the measured output values with predetermined output values corresponding to the material classification data.

30. The operation method according to claim 29, wherein the acquiring of the material information of the cooking container includes:
calculating errors between the measured output values and the predetermined output values; and
recognizing a material of the cooking container as having a smallest sum of the calculated errors.

31. The operation method according to claim 30, further comprising:
receiving a heating command for the cooking container; and
operating in a heating mode according to the heating command,
wherein the measuring of the output values and the acquiring of the material information of the cooking container are performed before operating in the heating mode.

32. The operation method according to claim 30, wherein the measuring of the output values comprises setting a range from a first frequency to a second frequency as the search frequency range,
wherein the first frequency is less than or equal to a maximum operating frequency of the cooktop, and
wherein the second frequency comprises an operating frequency corresponding to a maximum power and a maximum current flowing through a working coil of the cooktop.

33. The operation method according to claim 32, wherein the measuring of the output values is performed while sequentially reducing the operating frequency from the first frequency to the second frequency.

34. The operation method according to claim 30, wherein second frequency is a minimum operating frequency of the cooktop.

35. A cooktop configured to heat a cooking container, the cooktop comprising:
an upper plate glass configured to receive a cooking container;
a working coil configured to generate a magnetic field so as to heat the cooking container;
an inverter configured to be driven to allow current to flow through the working coil;
a measurement unit configured to measure output values within a search frequency range; and
a processor configured to compare the measured output values with predetermined output values to determine a material of the cooking container.

36. The cooktop according to claim 35, wherein the processor is further configured to:
calculate errors between the measured output values and the predetermined output values; and
calculate a sum of the errors through a sum operation of absolute values of the errors.

37. The cooktop according to claim 36, wherein the processor is further configured to determine the material of the cooking container as having a smallest sum of the calculated errors.
